(19) United States
(12) Patent Application Publication
(10) Pub. No.: US 2015/0258880 A1
(43) Pub. Date: Sep. 17, 2015

(54) Vehicle Door Dent, Ding and Scratch Protector and Protective Device

(71) Applicant: Robert Charles Wheeler, San Diego, CA (US)

(72) Inventor: Robert Charles Wheeler, San Diego, CA (US)

(21) Appl. No.: 14/215,588

(22) Filed: Mar. 17, 2014

(51) Int. Cl. B60J 11/06; B60R 19/42

(52) U.S. Cl. CPC B60J 11/06; B60R 19/42

(57) ABSTRACT

A Vehicle Door Dent, Ding and Scratch Protector and Protective Device, comprising of a nominal five piece high density-soft padding covered in a soft Water Resistant material that fits around the vehicle and protects the drivers and passengers sides of the vehicle from minor dent, dings and scratches, caused by the opening of vehicle doors parked too close, and protection from other objects that may fall while resting against an unstable resting area. The protective Device not only protects but has also been designed to add beauty and elegance to the vehicle it protects.

### BACKGROUND OF THE INVENTION

1. Field of Invention

The present invention relates to the doors, quarter panels, trunk, hood, and bumpers protection device for use in connection with a vehicle. The doors, quarter panels, trunk, hood and bumpers protection device has particular utility in connection with protecting a parked vehicle from damage caused by other vehicles parked too close, people walking by, or unattended, unstable objects such as garden tools and bicycles.

2. Background of Invention

This U.S. Pat. No. 4,707,009 does not disclose the five piece nominal inward outward accordion folding padding, the padded mirror covers, or the two separate straps with suction devices and removal devices that hold the protective device of the present invention in place.

This U.S. Pat. No. 4,750,767 does not disclose the five piece nominal inward outward accordion folding padding, nor the two separate straps with suction devices that hold the protective device of the present invention in place.

This U.S. Pat. No. 5,050,925 does not disclose the five piece nominal inward outward accordion folding padding, nor the two separate straps with suction devices that hold the protective device of the present invention in place. In addition each pair of the five piece conjoined padding material is covered with a soft water resistant material that conjoins with the front and rear bumper protective device.

This U.S. Pat. No. 6,062,617 does not disclose the protective front and rear bumper protective material. It also does not disclose the five piece nominal inward outward accordion folding padding, nor the two separate straps with suction devices that hold the protective device up on the present invention in place. In addition, each pair of the five piece conjoined padding material is covered with a soft water resistant material and can and does conjoin with the front and rear bumper protective device.

These patents, or known prior uses, teach and disclose various types of devices for protecting the finish on automobiles, as well as methods of their construction; but none of them, whether taken singly or in combination, disclose the specific details of the combination of the invention as to bear upon the claims of the present invention and its protect ability. In addition, each pair of the five piece conjoined padding material is covered with a soft water resistant material and can and does conjoin with the front and rear bumper protective device providing the ultimate vehicle protection.

The present invention resides not in any one of these features, but perhaps in the articulate motive and intention of all of them wherein the main focus and direct intent is to eliminate the unforeseen and unintentional damages to vehicles caused by dents, dings, and scratch damages mostly caused by the unintentional opening of a door by other vehicles parked too close after the vehicle has been parked and left unattended. It is herein disclosed and claimed, and it is distinguished from the prior art in its particular combination of its design, and structures for the functions specified and revealed in this invention.

From the beginning of the invention of the automobile, the body and finish has been overwhelmed with unintentional dents, dings and scratches caused by an adjacent vehicle parking too close to a vehicle after it has been parked and left unattended. As a result, numerous inventions have been designed to cope with the problem yet the problem still exists to the current day and ongoing as the problem grows even larger. The present invention provides a protective vehicle body guard utilizing a soft, lightweight, high density material that protects the vehicle's finish from dents, dings, and scratches. The solution offered which is detailed in the present invention gives the user peace of mind to leave their vehicle unattended in any location especially in parking lots that do not offer adequate spacing between parked vehicles. Still another object of the present invention is to provide a new and improved protective vehicle body protective device wherein my invention has detailed the advantages overcoming the challenges and the disadvantages normally associated with the level of body protection therewith.

The present invention is outlined rather broadly. The more important features of the invention in great detail, and featured options are listed in the patent as SUV Rear Bumper Protector Bonnet, padded mirror covers that attach to the protective device, padded front and rear protector bonnets, anti-theft tabs that attach to the inner surface of the protective device to be placed in the door jamb between the window and door frame of the vehicle to prevent unauthorized removal of the protective device.

The present invention also takes into consideration the end user and their differences in physical body structure in that it recognizes size and height differences between individuals. The present invention offers optional connecting support belts and adjustable connectors as well as connectors that lock and unlock allowing the present invention to be installed much easier in a manner that suits the end user.

The said invention because of the panel interior and exterior hinging accordion style and folding design is easy to fold which makes it easy to store. The present invention is also designed specifically to snug the body so there is no chance of blowing off and away from the vehicle during high winds.

It is also in that the detailed description and configuration doesn't just select portions of side section of a vehicle for protection coverage, but offers protection to the complete outer perimeter of the vehicle including the front and rear drivers and passengers side doors, mirrors, front and rear quarter panels, front and rear bumpers, and the trunk and hood.

It is in that the detailed description thereof that follows may be better understood and in order that the present contributions to the present invention provide a new and improved vehicle body protective device that is durable, reliable, water resistant, versatile, marketable and interesting.

The present invention within this patent is specifically engineered to protect the vehicle, but also in its design is the intentional makeup of its sleek visual as it appears on the vehicle body and a fit that adds beauty to the vehicle giving the customer a greater since of value and ownership. For a better understanding of the invention, its operating advantages, alternative options, and the specific objects attained by its uses, reference should be had to the accompanying Figures and descriptive matter in which there are illustrated preferred embodiments of the invention.

### DESCRIPTION OF THE PRIOR ART

### Description of Referenced Patents

Various prior art automobile door guards and their similarities, as well as the method of their construction in general, are known and are found to be exemplary of the U.S. prior art. They are:

U.S. Pat. No. 4,707,009 to John L. Barnett discloses a side protector with infancies of a saddle bag style protector. The protective device in John L. Barnett's patent is a three piece inward folding device with a single wide strap that lies over the car connecting the two side proactive pieces together.

U.S. Pat. No. 4,750,767 to John L. Barnett discloses a side protector with infancies of a saddle bag style protector. The support band is inserted at the top of an automobile door and the protective pad hangs downwardly and outwardly along the side of the car to be protected. The protective device is a three piece inward folding device with a single wide strap that lies over the car connecting the two side proactive pieces together.

U.S. Pat. No. 5,050,925 to Larry E. Brown discloses a removable protective padding for preventing chips, dents, scrapes and nicks to the doors and sides of a parked vehicle which is covered by this protective padding. Larry E. Brown's patent also discloses its protective device is held in position by magnets. The side protector is made of a clear plastic material.

U.S. Pat. No. 6,062,617 to Monte P. Marks discloses a foldable, protector that can be stowed away with a “U” shaped clamp that slides over an automobile door edge that is used for holding the protector in place on the automobile. The protector “U” shaped clamp has a female Velcro strip disposed on one inner surface thereof for engaging a male Velcro strip attached to the inner surface of the automobile door edge for holding said protector in place. The protector has a mounting bracket that is generally “T” shaped.

### SUMMARY OF THE INVENTION

The present invention provides a protective guard to the outer structure of a vehicle body. The invention comprises of a nominal five piece soft light weight high density padding covered in a soft water resistant material. The objective is to prevent accidental dents, dings, and scratches caused mostly by the opening of other vehicles doors parked too close. The present invention is a removable device that is not limited in size, shape, or configuration. Typically the said invention dimensions length and width may vary depending on the make and or model of the vehicle. The front and rear soft material section of the present invention adds protection to the front and rear bumper.

One of the important objects is that the present invention fits the vehicle body snug as if wearing a glove. This important feature related to the front and rear bumper areas of the vehicle prevents the protective device from blowing away. The present invention fits around the vehicle and protects the front and rear driver side doors, front and rear passenger side doors, front and rear bumpers, front and rear quarter panels, and front hood and rear trunk from minor dents, dings, and scratches. The present invention is designed with alternate protection options which can be viewed together with additional objects and advantages best understood from the viewing of the following written descriptions of the embodiments.

An important object of the present invention is to provide alternative options that does extend the protection ability and further advance the invention itself in its construction and intent. The alternative features which are considered important characteristic for the present invention which include extreme lightweight materials for ease of installation, easy storage ability and an unwanted removal deterrent are set forth in the claims and drawings of this patent. As noted above, the present invention is a vehicle protective device intended to reduce as well as the intent to eliminate the minor dents and dings caused by the opening of a vehicle door to the exterior body of an adjacent vehicle.

### BRIEF DESCRIPTION OF DRAWINGS

FIG. 1: illustrates a Driver and Passenger five piece Protective Device. It details the basic construction and assembly of the five piece padding, support belt and suction devices.

FIG. 2: illustrates a Collapsible View of the five piece padding and how it folds.

FIG. 3: illustrates what is called a Front Bumper Protector Bonnet. It details the method in which it is assembled, the use of the water resistant material and the basic dimensions.

FIG. 4: is a Rear Bumper Protector Bonnet. It details the method in which it is assembled, the use of the water resistant material and the basic dimensions.

FIG. 5: illustrates a Front and Rear Bumper Protector Bonnet conjoined to side padding. It details the method in which it is assembled, the use of the water resistant material and the basic dimensions.

FIG. 5a: illustrates an Exploded View of a suction device, a removal device, a Grommet, and the support belt.

FIG. 6: illustrates a Door Dent, Ding and Scratch Protector and Protective Device Detailed View. It details the method in which it is used to protect a vehicle.

FIG. 7: illustrates an alternative option to the current invention option to the current invention with Padded Mirror Covers Driver and Passenger Side Protection Only.

FIG. 8: illustrates an alternative option to the current invention with a Top Protection option.

FIG. 9: illustrates an alternative option to the current invention with driver to passenger connecting support belts and locking and unlocking connectors.

FIG. 10: illustrates an alternative option to the current invention Rear Bumper Protector Bonnet section. This option is designed for the protection of SUV type and hatch back type vehicles.

FIG. 11: illustrates an alternative option to the current invention Front and Rear Bumper Protector Bonnet section. It details the method for use of connectors that allow for locking and unlocking of an opened section in the rear protector bonnet.

FIG. 12: illustrates an alternative option to the current invention with adjustable connectors. It details the method for use of two support belt and connectors that allow for the adjustment of the support belts.

FIG. 13: illustrates an alternative option to the current invention. It details the method for use of two support belt, suction devices and removal devices that allow for the protective device to attach to the rear window of an SUV or hatchback type vehicle.

FIG. 14: illustrates an alternative option to the current invention. It details the method for use of soft padding sewn in the lining of the Front and Rear Bumper Protector Bonnet.

FIG. 15: illustrates an alternative option to the current invention. It details the method for use of soft padding sewn in the lining of the bumper protector.

FIG. 16: illustrates an alternative option to the current invention. It details the Front and Rear Bumper Protector Bonnet conjoined to driver and passenger side padding with padding sewn in the lining of the Front and Rear Bumper Protective Bonnet.

### DETAILED DESCRIPTION

### Description of the Figures

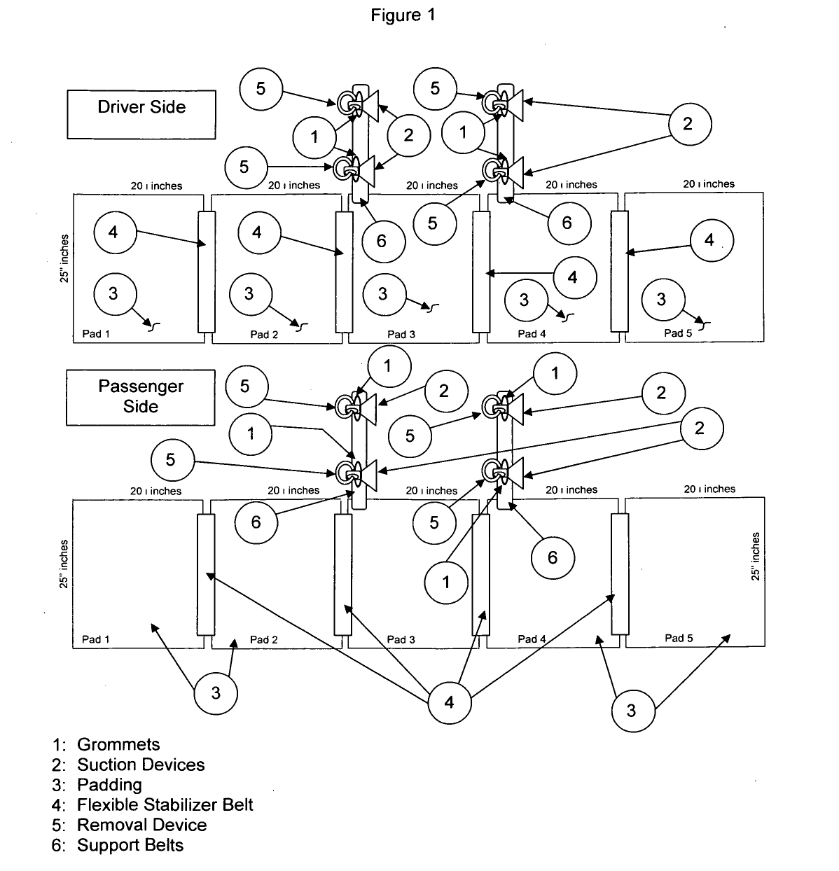

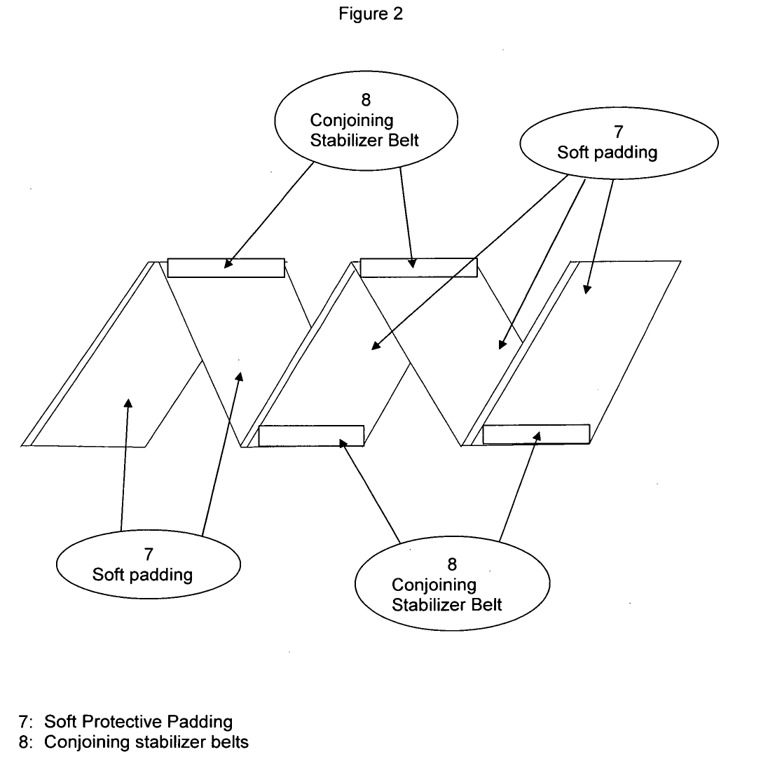

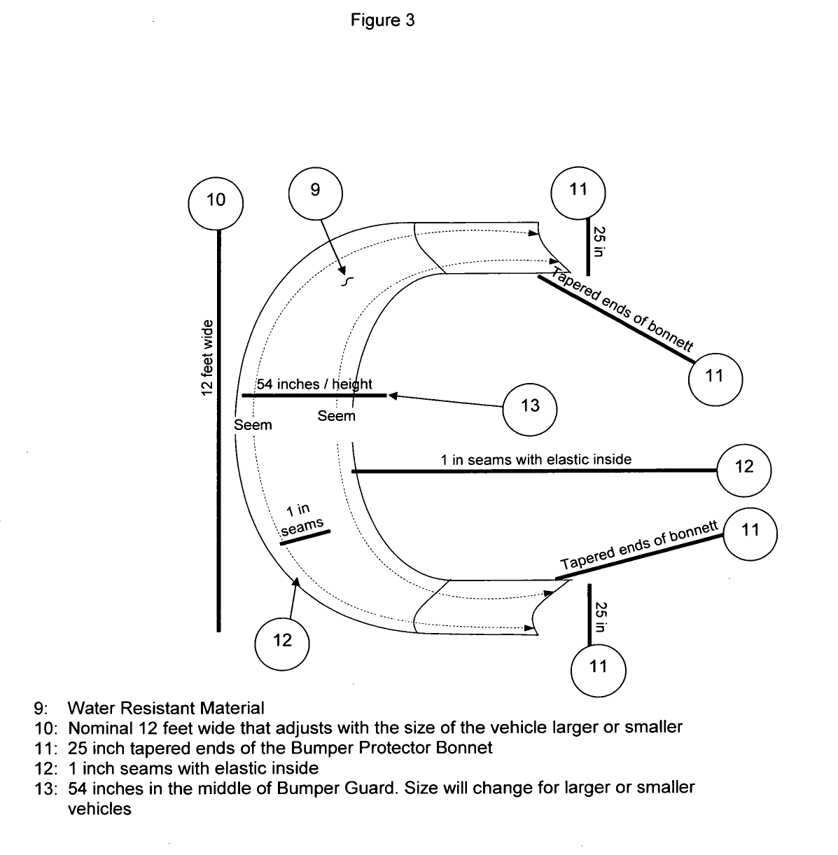

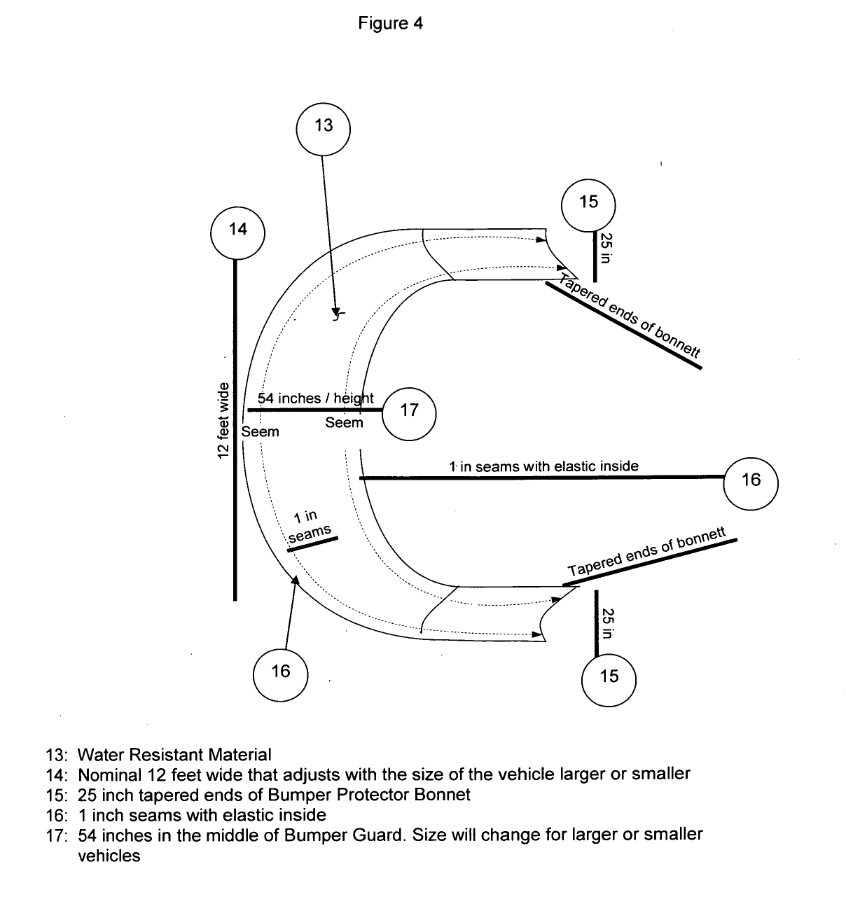

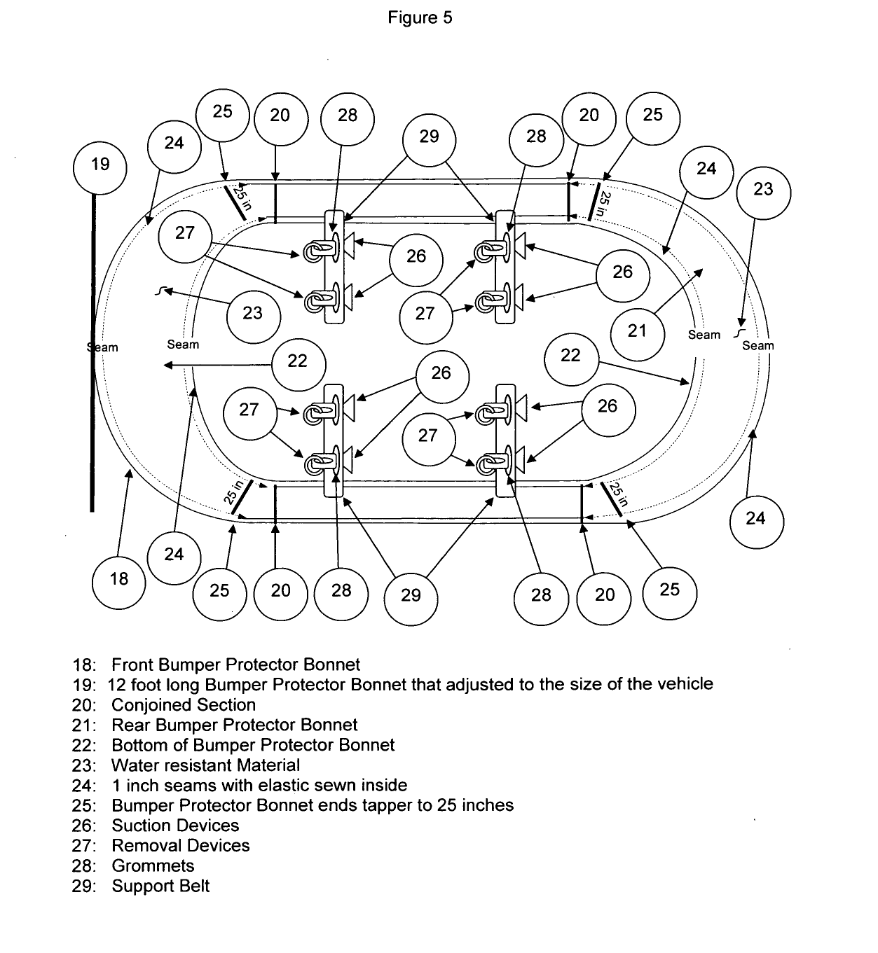

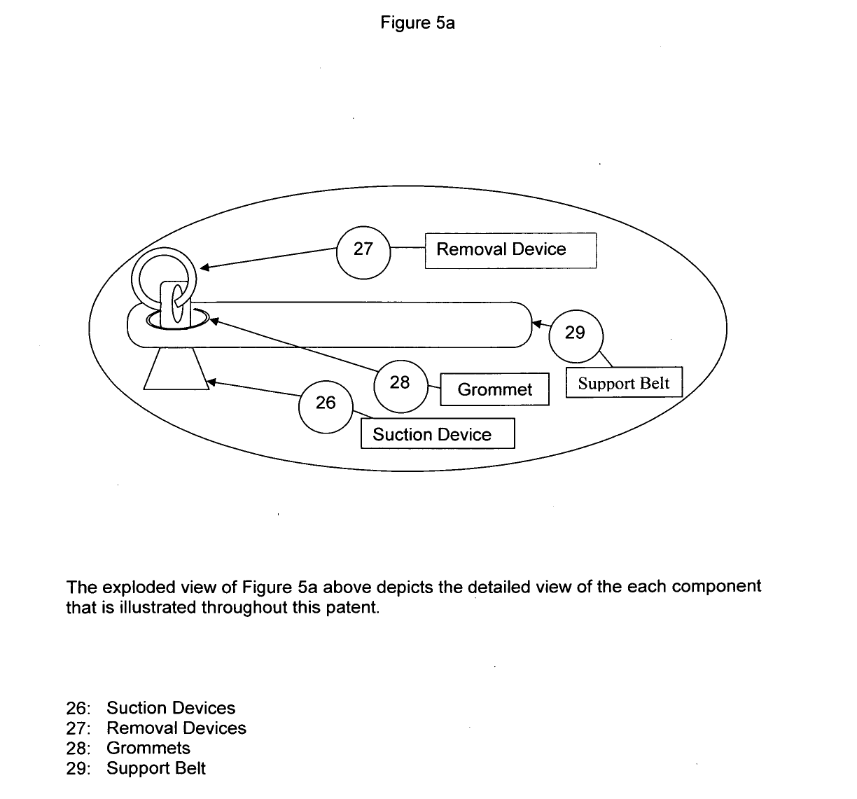

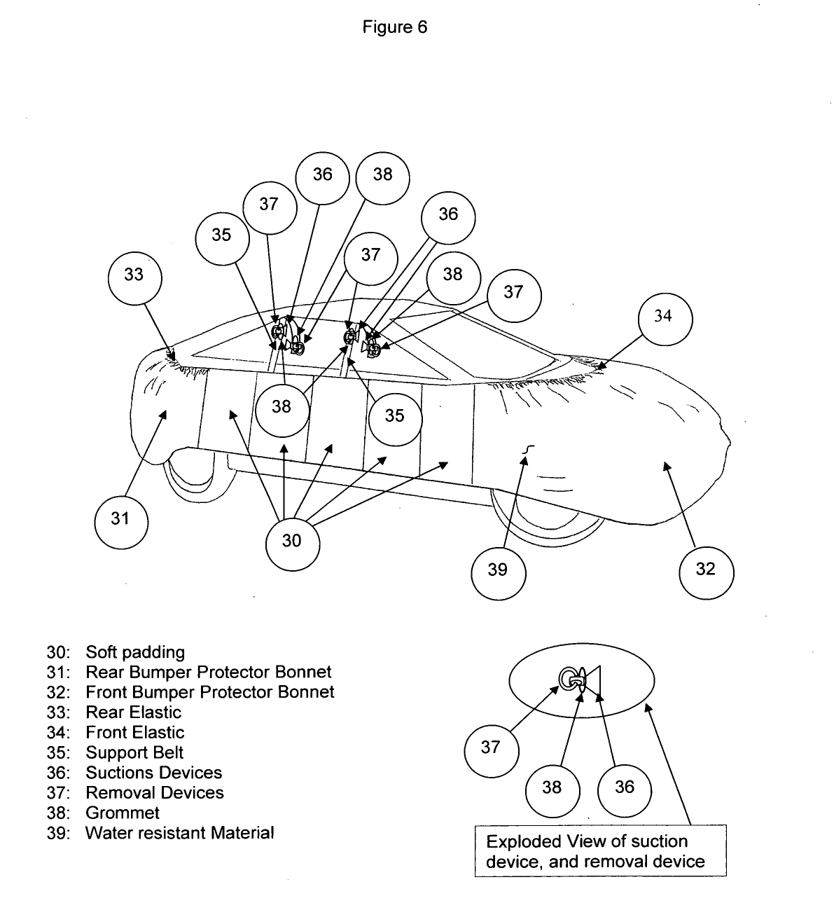

Preferred embodiments of the present invention are illustrated in FIG. 1, FIG. 2, FIG. 3, FIG. 4, FIG. 5, and FIG. 6.

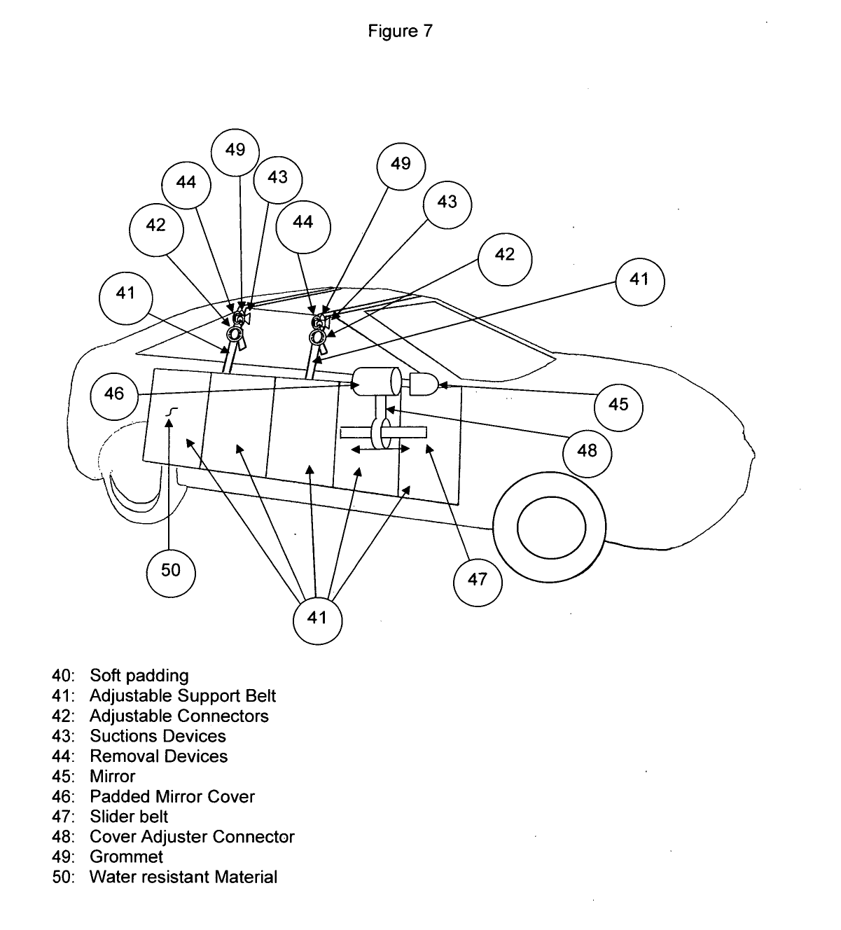

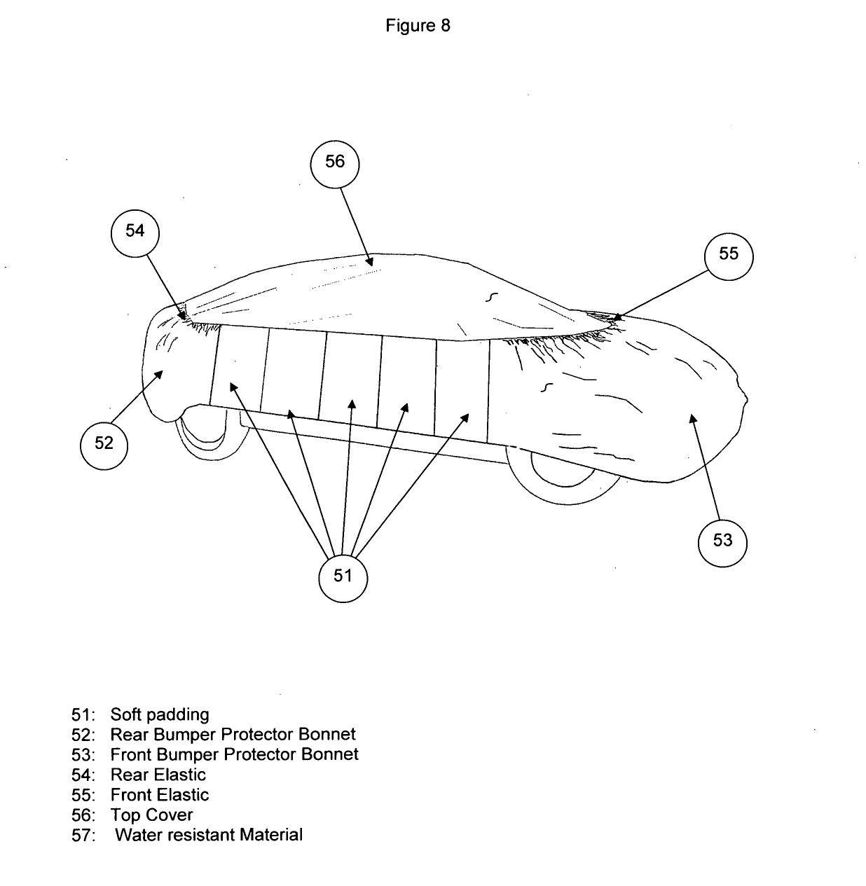

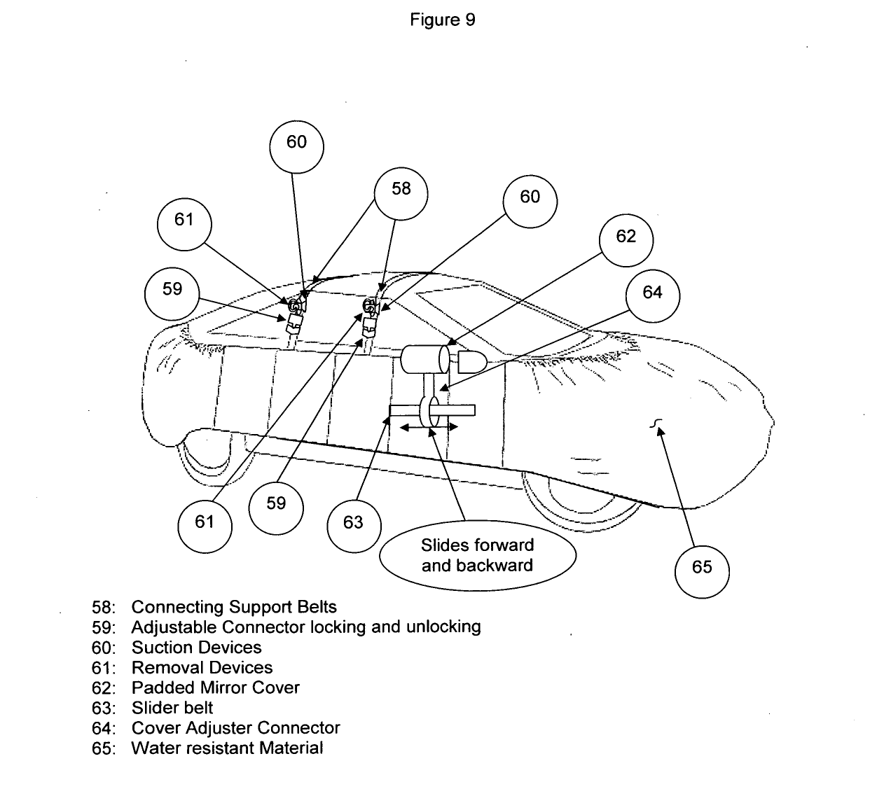

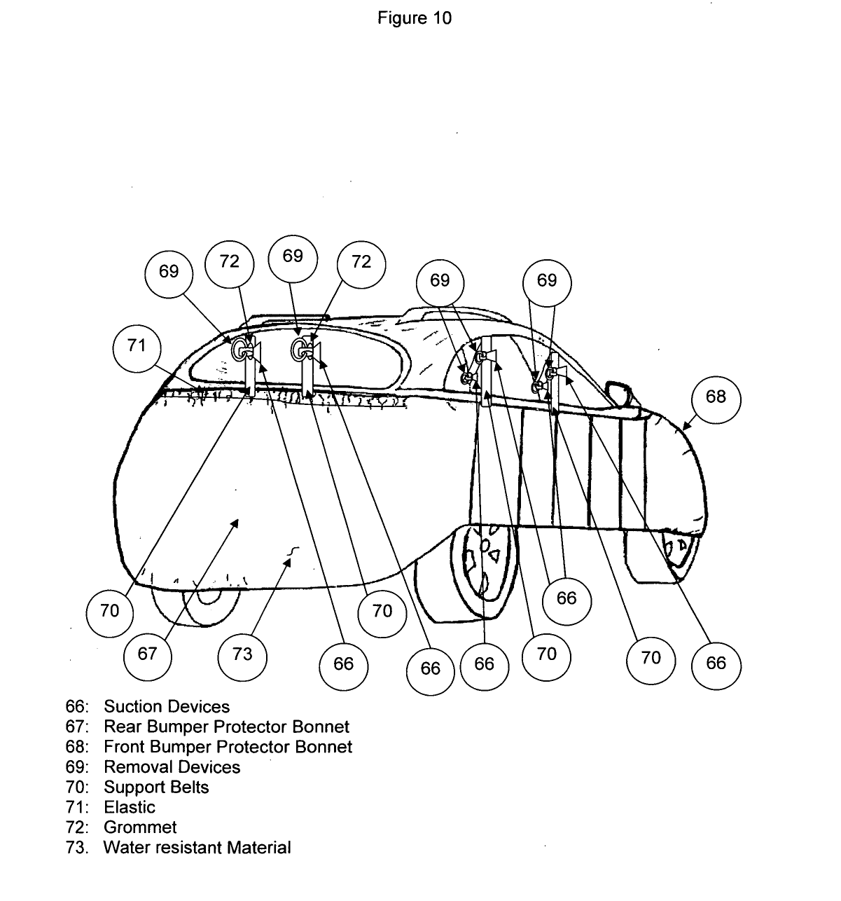

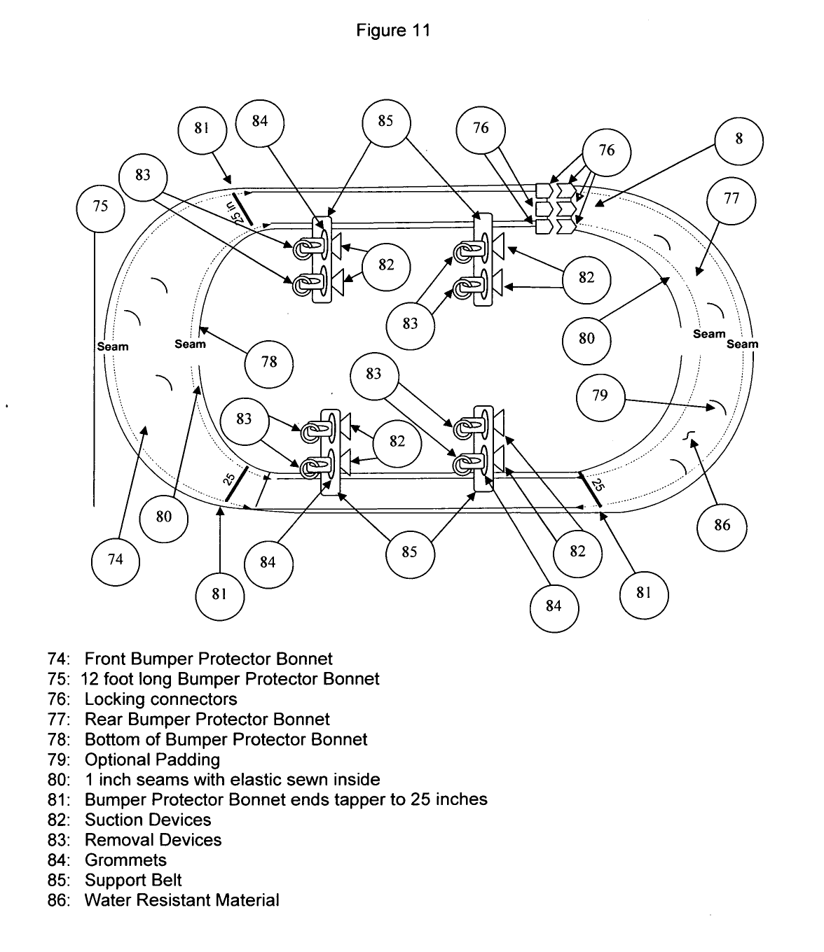

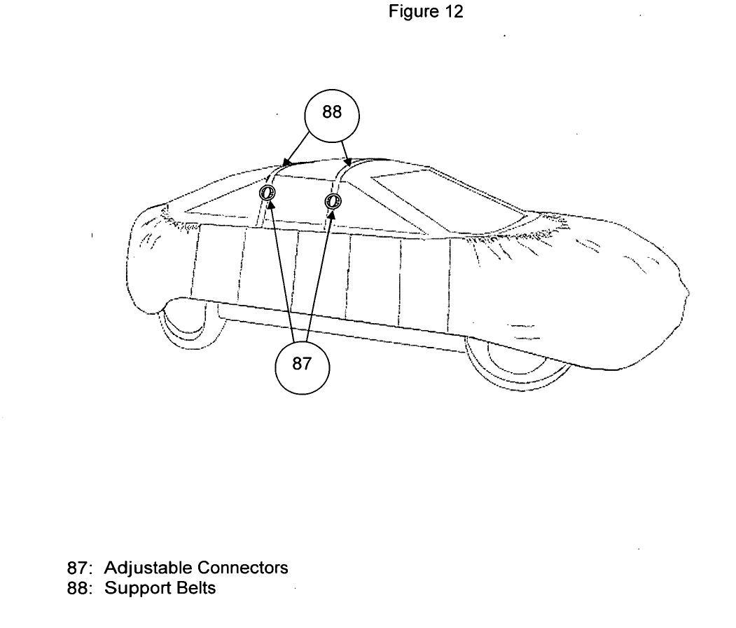

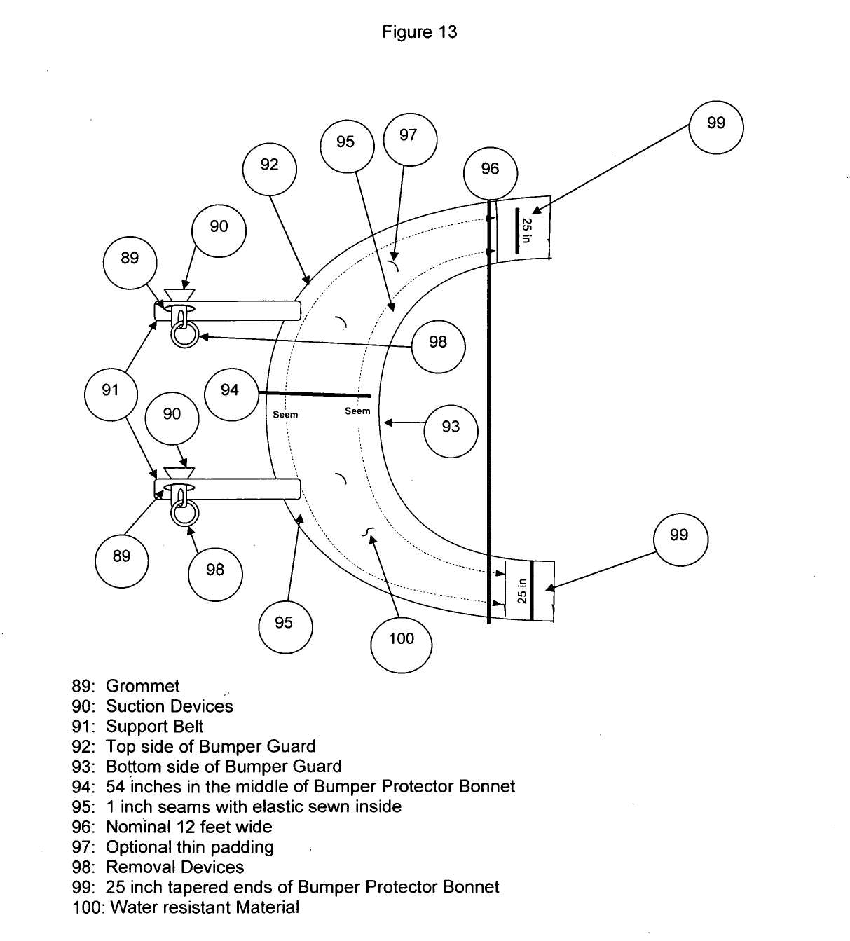

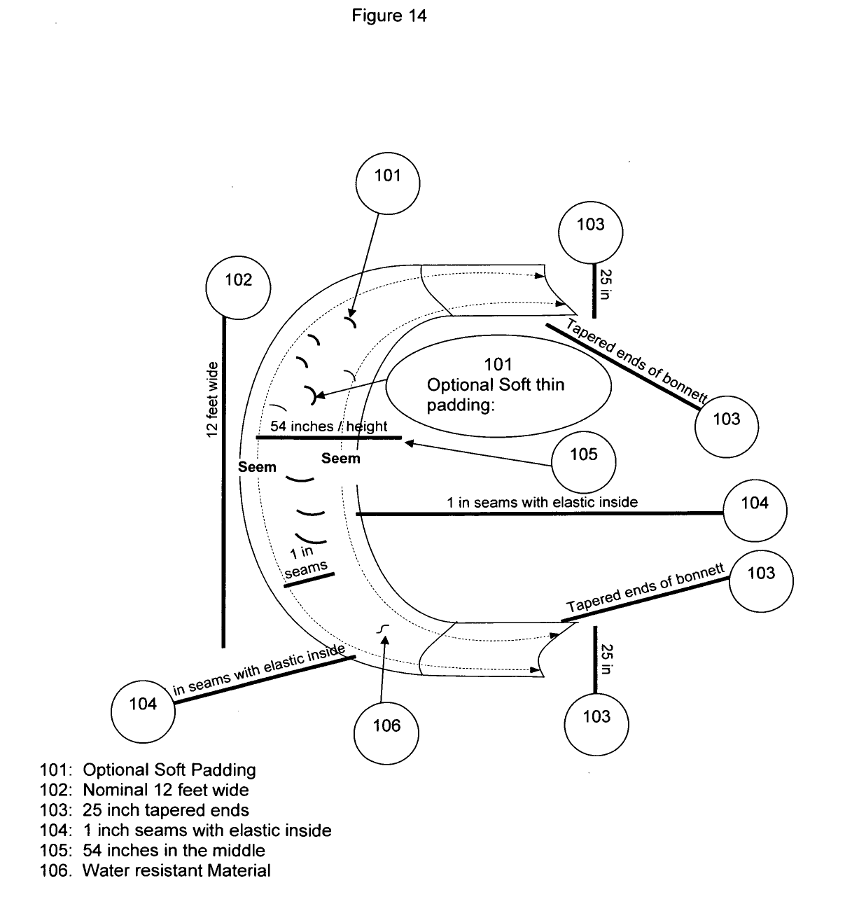

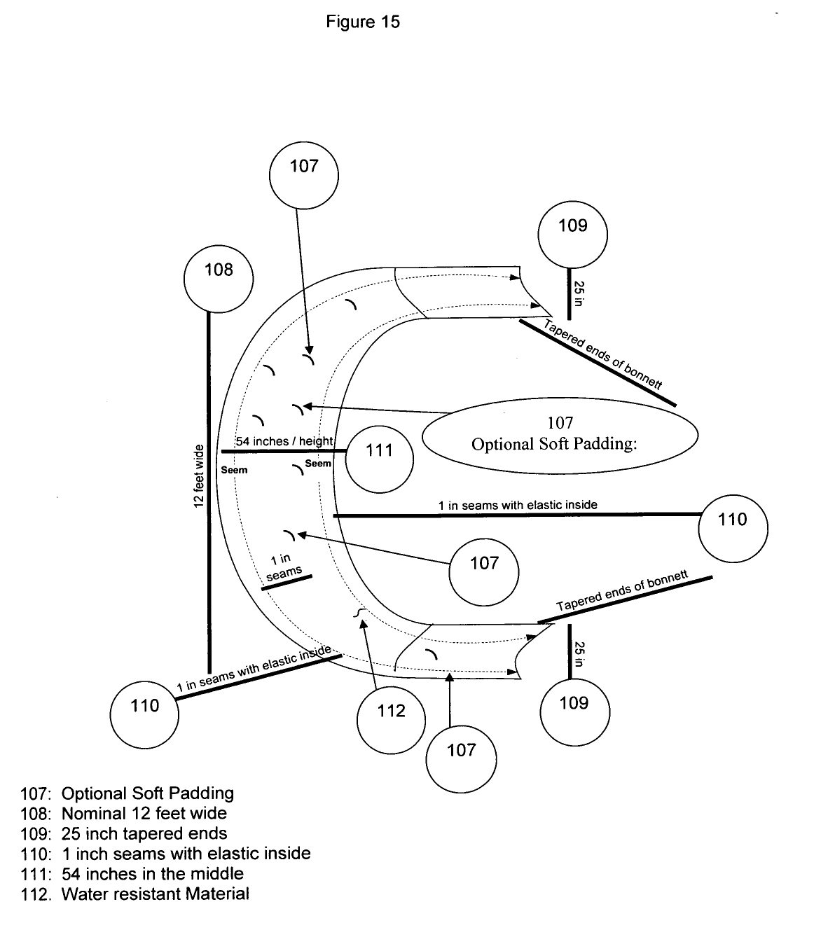

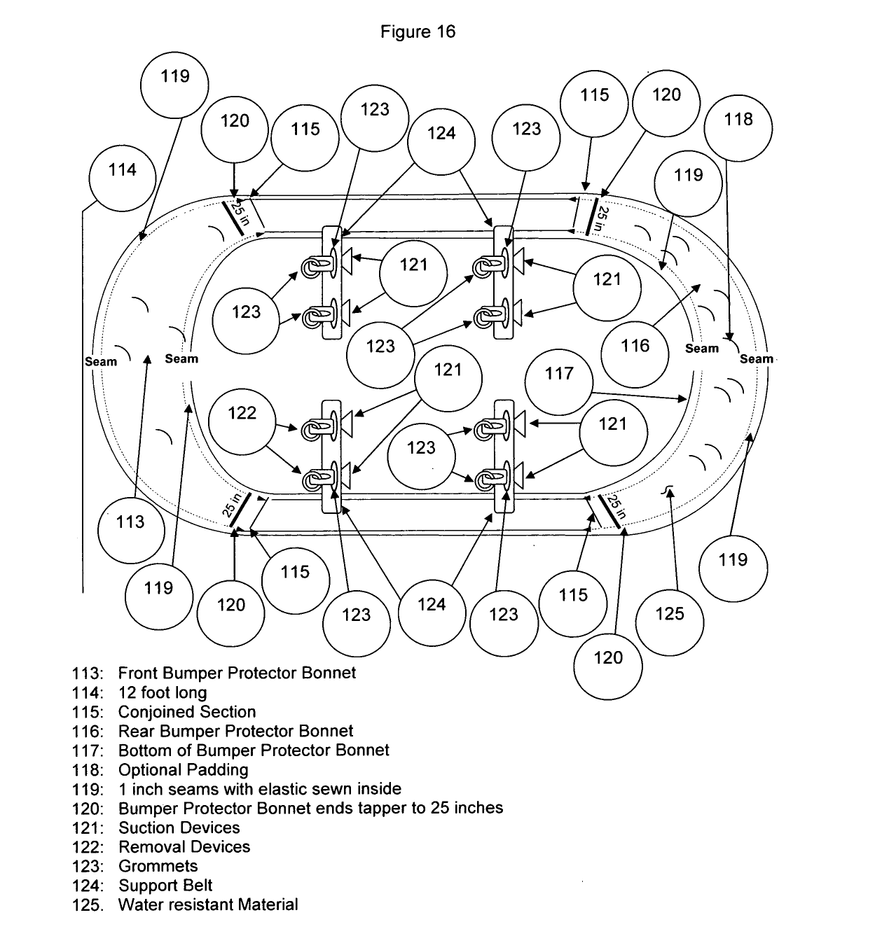

Alterative embodiments and options of the preferred embodiment are illustrated in FIG. 7, FIG. 8, FIG. 9, FIG. 10, FIG. 11, FIG. 12, FIG. 13, FIG. 14, FIG. 15, and FIG. 16. These are alterative embodiments and options of the preferred embodiment of this current patent Vehicle Door Dent, Dings, and Scratch Protector and Protective Device and are listed in detail below.

### FIG. 1: Driver and Passenger Protective Device Padding Assembly

FIG. 1 illustrates a Driver and Passenger Protective Device padding assembly that is made of a nominal five piece conjoined foldout soft padding material that is applied to both the driver and passenger side, as shown in FIG. 1: 3. Each piece of soft padding is attached and conjoined to each other by one or more flexible stabilizer belts for added hinging stability as seen in FIG. 1: 4. The belts are located between each connecting fold and positioned on the opposite side of each separation also known as joint.

The flexible stabilizer belts allows for strength and stability and also allows each section to fold inward and outward allowing the device to fold and collapse in an accordion type of fold for ease of storage as shown in FIG. 2: 2.

The belts also protect each section from separating during installation and storage return after removing the device from the vehicle. To fit larger or much smaller vehicles one or more panels sections of the soft padding conjoined foldout can be added or removed from both the driver's side and passenger's side of the protective device.

Both driver and passenger side has two support belts with suction devices attached to the protective padding. Each belt has two grommets with a design such as a circle with a hole in the center which allows a suction device to feed through it and attach to the support belt. The suction devices are attached to the top and bottom section of the support belt with removal devices attached to the suction devices.

### FIG. 2: Collapsible Views

FIG. 2 illustrates a collapsible view of the vehicle door dents, dings, and scratch protector which is made of a nominal five piece conjoined foldout soft padding material. Each piece is attached and conjoined to each other by one or more flexible stabilizer belts for hinging and stability. The collapsible view illustrates how the padding pieces will fold. FIG. 2: 7, Soft Padding Material, FIG. 2: 8, Conjoining Stabilizer. This view illustrates how the protective device hinging allows for collapsing.

### FIG. 3: Front Bumper Protector Bonnet

FIG. 3 illustrates a Front Bumper Protector Bonnet soft fabric water resistant material which is defined as the Front Bumper Protector Bonnet as it covers the bumper like that of a protective bonnet protecting the bumper from minor damage. The Front Bumper Protector Bonnet is a vehicle standard size of 12 feet in length and can be made larger or smaller varying in size depending on the size of the vehicle. The variation is 8 feet or can be made smaller in length for smaller vehicles, and up to 16 feet in length or longer for larger vehicles depending on the length and size of the vehicle. The width of each Front Bumper Protector Bonnet is 54 inches and can be made larger or smaller varying in size depending on the size of the vehicle. The ends of the Front Bumper Protector Bonnet tappers down from a width of 54 inches at the center of the Front Bumper Protector Bonnet to a width of 25 inches at each end. Both ends are attached and joined together with the remaining five pieces of the soft padding on the drivers and passenger's side protection device which makes up the vehicle door dent, ding, and scratch protector.

The Front Bumper Protector Bonnet is covered in a water resistant material as seen in FIG. 3: 1 that adds a higher degree of protection to the front bumper from unseen accidental scratches.

FIG. 3, 9: water resistant material, FIG. 3: 10, Nominal 12 feet wide that fits to the shape and size of the vehicle bumper, FIG. 3: 11, 25 inch tapered ends of the Front Bumper Protector Bonnet, as seen in FIG. 4: 12, 1 inch seams with elastic inside the hem, FIG. 3: 13, 54 inches in the middle of Bumper Guard adjustable for larger or smaller Vehicles.

### FIG. 4: Rear Bumper Protector Bonnet

FIG. 4 illustrates a Rear Bumper Protector Bonnet soft fabric water resistant material that is defined as the Rear Bumper Protector Bonnet as it covers the bumper like that of a protective bonnet protecting the bumper form minor damage. The Rear Bumper Protector Bonnet is a vehicle standard size of 12 feet in length and can be made larger or smaller varying in size depending on the size of the vehicle. The variation is 8 feet or made smaller in length for smaller vehicles, and up to 16 feet in length or longer for larger vehicles depending on the length and size of the vehicle. The width of each Rear Bumper Protector Bonnet is 54 inches and can be made larger or smaller varying in size depending on the size of the vehicle. The ends of the Rear Bumper Protector Bonnet tappers down from a width of 54 inches at the center of the Rear Bumper Protector Bonnet to a width of 25 inches at each end. Both ends are attached and joined together with the remaining five pieces soft padding drivers and passengers side protection device which makes up the vehicle door dent, dings, and scratch protector.

The Rear Bumper Protector Bonnet is a water resistant material as seen in FIG. 4: 13 that adds a higher degree of protection to the front bumper from unseen accidental scratches.

FIG. 4, 13: water resistant material as seen in (FIG. 4: 14) Nominal 12 feet wide that Fit to the shape and size of the vehicle bumper, see (FIG. 4: 15) 25 inch tapered ends of the Rear Bumper Protector Bonnet, as seen in (FIG. 4: 16) 1 inch seams with elastic inside hem, as seen in (FIG. 4: 17) 54 inches in the middle of Bumper Guard adjustable for larger or smaller Vehicles.

### FIG. 5: Front and Rear Bumper Protector Bonnet Conjoined to Side Padding.

FIG. 5 illustrates a complete Vehicle Door Dent, Ding, and Scratch Protective Device that protects the driver's and passenger's doors and quarter panels from minor dents, dings and scratches. The protective device is covered in a soft water resistant material. The protective device is a nominal five piece padded sheets conjoined with the Front and Rear Bumper Protector Bonnet. The padded sheets can be configured to fit larger or smaller vehicle by adding or removing one or more soft padded sheets.

The vehicle door dent, ding, and scratch protector and protective device protects the front and rear bumper with an added water resistant material (23) with contoured ends that conjoins to the ends of both drivers and passengers side nominal 5 piece soft padding protective sheets. This device allows the protective device to fit snug preventing the protective device from blowing off during a strong wind. Both driver and passenger side has two support belts (29) attached to the protective padding. Each belt has two grommets (28) with a design such as a circle with a hole in the center which allows a suction device to feed through it and attach to the support belt. At the end of each suction device is a removal device (10) such as a ring or another suitable type of removal device that is designed to remove the device from the vehicle. The suction devices are attached to the top and bottom section of the support belt. The Front and Rear Bumper Protector Bonnet conjoined with the side padding showing all pieces as one complete assembly. FIG. 5 illustrates all pieces including the front and rear bumper protective bonnet as one assembly.

FIG. 5, 18: Front Bumper Protector Bonnet, 19: 12 foot long Bumper Protector Bonnet that adjusted to the size of the vehicle, 20: Conjoined Section, 21: Rear Bumper Protector Bonnet,

22: Bottom of Bumper Protector Bonnet, 23: water resistant material, 24: 1 inch seams with elastic sewn inside, 25: Bumper Protector Bonnet ends tapper to 25 inches, 26: Suction Devices, 27: Removal Devices, 28: Grommets, 29: Support Belt

FIG. 5a: Exploded View of Suction Device, Removal Device, Grommet, and Support Belt

FIG. 5a is the exploded view of a suction device, removal device, Grommet, and support belt that depicts the detailed view of the each component illustrated throughout this patent. 26: Suction Devices, 27: Removal Devices, 28: Grommets, 29: Support Belt

### FIG. 6: Vehicle Door Dent and Scratch Protector Viewed Detailed

FIG. 6 illustrates a soft five piece padded (30) vehicle door dent, ding, and scratch protective device covered with a water resistant material (39) that protects the drivers and passengers doors and quarter panels from minor dents, dings and scratches. The protective device is covered in a soft Water Resistant material. The protective device is a nominal five piece conjoined padded sheets (30) that can be made to fit larger or smaller vehicle by adding or removing one or more soft padded sheets.

The protective device also protects the front and rear bumper with added water resistant material detailed as Front and Rear Bumper Protector Bonnet. The rear bumper protector bonnet (31) and front bumper protector bonnet (32) is a very strong light weight water resistant material that is designed with contoured ends and elastic (34) sewn in the seams. The Bumper Protective Bonnets are attached and or conjoined to the ends of both driver and passenger side soft padding protective sheets. The elastic in the front and rear bumper protector section allows the protective device to fit snug preventing the protective device from blowing off during a strong wind.

The protective device has two support belts (35), each with two suction devices (36), two removal devices (37), and two grommets (38) attached to each belt. The suction devices, grommets and removal devices are attached to the top and bottom section of each belt. The two support belts (35) are conjoined to the protective padding. Each belt has two grommets (38) with a design such as a circle with a hole in the center which allows the suction device to feed through it and attach to the support belt. At the end of the suction device is a removal device (37) such as a ring or another suitable type of removal device that is used to assist with the removal of the suction device from the vehicle when uninstalling the Door Dent and Ding, Scratch Protector and Protective Device.

FIG. 6, 30: Soft Padding, 31: Rear Bumper Protector Bonnet Bumper 32: Front Bumper Protector Bonnet, 33: Rear Elastic, 34: Front Elastic, 35: Support belts, 36: Suctions Devices, 37: Removal Devices, 38: Grommet, 39: Water Resistant Material

### FIG. 7: Vehicle Door Dent and Ding, Scratch Protector and Protective Device Driver and Passenger Side Protection Only

FIG. 7 illustrates an alternative embodiment option covered with a water resistant material (50) that removes the front and rear Bumper Protector Bonnet from the Vehicle Door Dent, Ding, and Scratch Protector and Protective Device five piece padding. The driver's side and passenger side are connected together with support belts (41) with adjustable connectors (42). On both the drivers and passenger side are Slider Belts (8) and padded mirror covers (46) attached to the five piece conjoined padding (1) that protects the mirror from being scratched by individuals passing by. The slider belts allow the padded mirror cover to slide forward and reverse giving it adjustability for vehicles with mirrors in different positions allowing the Padded Mirror Cover to fit any vehicle.

The protective device has two adjustable support belts (41) with two suction devices (43) and removal device (44) attached to each belt. The suction devices are attached to the top section of the belt. Each belt has two grommets (49) with a design such as a circle with a hole in the center which allows the suction device to feed through it and attach to the support belt. At the end of the suction device is a removal device (5) such as a ring or another suitable type of removal device that is used to remove the device from the vehicle. The suction devices are attached to the top section of the support belt on both the driver and passenger side. The two side connector together with adjustable connectors (42) that join the belts together over the roof of the vehicle that allow the user to adjust the belts to fit the width and size of their vehicle specification.

Additionally this option can be configured to protect targeted areas of the vehicle by moving the protective device forward or back changing the positioning of the protective device allowing ultimate protective positioning for the vehicle. At the end of the support belt is added belt length that is designed to be closed between the door jam and door frame of the vehicle. The added belt length acts as a deterrent which helps prevents unwanted removal of the protective device. This option can be configured with Two padding sheet, and up to as many as the end user requires to protect their vehicle.

FIG. 7, 40: Soft padding, 41: Adjustable Support Belt, 42: Adjustable Connectors, 43: Suctions Devices, 44: Removal Devices, 45: Mirror, 46: Padded Mirror Cover, 47: Slider belt, 48: Cover Adjuster Connector, 49: grommet, 50: Water Resistant Material
FIG. 8: Vehicle Door Dent, Ding and Scratch Protective Device with Top Protector

FIG. 8 illustrates an alternative protective device covered with a water resistant material (7) option with an added top section (6) of water resistant material to protect the top section of the Vehicle. The added top section protects the top of the vehicle from the elements and dust when sitting for long periods of time. By adding this section to the protective device it becomes a full Vehicle Protective Device protecting the drivers and passengers sides from minor dents, dings and scratches, the front and rear bumper from scratches, and protecting the top from minor scratches, abrasive garage dust and the elements.

FIG. 8, 51: Soft padding, 52: Rear Bumper Protector Bonnet Cover, 53: Front Bumper Protector Bonnet Cover, 54: Rear Elastic, 55: Front Elastic, 56: Top proactive cover, 57: Water Resistant Material

FIG. 9: Vehicle Door Dent, Ding and Scratch Protector and Protective Device with Driver to Passenger Connecting Support Belts and Locking and Unlocking Connectors

FIG. 9 illustrates an alternative option to the Vehicle Door Dent, Ding and Scratch Protector and Protective Device. The option adds driver to passenger locking and unlocking adjustable

connector to the support belt (58). The connectors allow the belts to adjust to fit different size vehicles and then lock when the size has been determined.

The locking and unlocking of the connectors helps with installing and uninstalling of the protective device. This option also has on both the driver and passenger side mirror protective covers (62) Slider Belts (63) and cover adjuster connector (64) that attaches to the five piece conjoined padding. The Padded Mirror Cover protects the mirrors from being scratched damaging the finish cause by individuals passing by. The slider belts allow the padded mirror cover to slide forward and reverse giving it adjustability for vehicles with mirrors in different positions allowing it to fit any vehicle.

FIG. 9, 58: connecting support belts, 59: Adjustable Connector locking and unlocking, 60: Suction Devices, 61: Removal Devices, 62: Padded Mirror Cover, 63: Slider belt, 64: Cover Adjuster Connector, 65: Water Resistant Material

### FIG. 10: Vehicle Door Dent, Ding and Scratch Protector and Protective Device SUV Rear Bumper Bonnet Protector

FIG. 10 illustrates an alternative option protective device with a rear Bumper Protector Bonnet covered with a water resistant material (73) designed to protect vehicles without an extended rear bumpers such as an SUV, and small economy cars with hatch backs. The SUV Rear Bumper Protector Bonnet has two support belts (70) with one suction device (67) attached to each belt. The SUV rear Bumper Protector Bonnet has two support belts (70) with one suction device (66) and a removal device (69) attached to each belt. Both support belts are designed with a grommet (72) such as a circular design with a hole in the center which allows a suction device to feed through it and is attached to the support belts. The suction devices are attached to the top section of the belt which keeps the device form fall during and after installation. At the end of the suction device is a removal device (69) such as a ring that is designed to assist with removable from the vehicle during uninstalling of the protective device. The SUV protective device also has elastic sewn in the seam which allows the protective device to fit snug around the rear section of the vehicle.

FIG. 10, 66: Suction Devices, 67: Rear Bumper Protector Bonnet, 68: Front Bumper Protector Bonnet, 69: Removal Devices, 70: Support Belts, 71: Elastic 72: Grommet, 73: Water Resistant Material

FIG. 11: Vehicle Door Dent, Ding and Scratch Protector and Protective Device with Locking Connectors

FIG. 11 illustrates an alternative option to the complete Vehicle Door Dent, Ding, and Scratch Protector and Protective Device. This option adds connectors that lock and unlock to the section where the five piece padding and Rear Bumper Protector Bonnet conjoin (3). The protective device protects the drivers and passengers doors and quarter panels from minor dents, dings and scratches. The protective device is covered in a soft water resistant material. The protective device is a nominal five piece padded sheets conjoined with the Front and Rear Bumper Protector Bonnet. The padded sheets can be configured to fit larger or smaller vehicle by adding or removing one or more soft padded sheets.

The door, dent, ding, and scratch protector and protective device also protects the front and rear bumper with an added fabric attachment designed with tapered ends (81) that is attached to the ends of both drivers and passengers side nominal 5 piece soft padding protective sheets. This protective device is designed as such that it allows the protective device to fit snug preventing the protective device from blowing off during a strong wind. Both driver and passenger side are equipped with two support belts (85) attached to the protective padding. Each belt has two grommets (84) with a design such as a circle with a hole in the center which allows a suction device to feed through the hole in the support belt. The suction device is used to attach to the window during installation. At the end of the suction device is a removal device (83) such as a ring that is designed to remove the suction device from the window assisting with the removal of the protective device from the vehicle. The suction devices are attached to the top and bottom section of the support belt. The Front and Rear Bumper Protector Bonnet conjoined with the driver and passenger side padding illustrates all pieces as one complete protective device.

FIG. 11: 74, Front Bumper Protector Bonnet, 75: 12 foot long Bumper Protector Bonnet that adjusted to the size of the vehicle 76: locking and unlocking connectors, 77: Rear Bumper Protector Bonnet, 78: Bottom of Bumper Protector Bonnet, 79: Optional Padding, 80: 1 inch seams with elastic sewn inside, 81: Bumper Protector Bonnet ends tapper to 25 inches, 82: Suction Devices, 83: Removal Devices, 84: Grommets, 85: Support Belt, 86: Water Resistant Material

FIG. 12: Vehicle Door Dent, Ding and Scratch Protector and Protective Device with Adjustable Connectors

FIG. 12 illustrates an alternative embodiment option protective device. The alternative option adds two support belts with adjustable connectors which permit the belts to be adjusted to fit different size vehicles. The belt are adjusted by sliding the connectors (87) up or down shorting or lengthening the support belt (88) until the protective device fits the desired specification of the vehicle owner.

FIG. 12: 87, Adjustable Connectors 88: Support Belts

### FIG. 13: SUV Rear Bumper Protector Bonnet

FIG. 13 illustrates an alternative embodiment Bonnet covered with a water resistant material (100) optioned to protect the rear section of vehicles without an extended rear bumpers such SUV and small economy cars. The SUV rear Bumper Protector Bonnet has two support belts with one suction device and a removal device attached to each belt. Both support belts are designed with a grommet such as a circular design with a hole in the center which allows a suction device (90) to feed through it and is attached to the support belts (91). The suction devices are attached to the top section of the belt which keepS the device form fall during and after installation. At the end of the suction device is a removal device (98) such as a ring that is designed to remove the device from the vehicle during uninstalling of the protective device.

Each belt has one grommet (89) with a design such as a circle with a hole in the center which allows a suction device to feed through the hole in the support belt. The suction device is used to attach to the window during installation. At the end of the suction device is a removal device (98) such as a ring that is designed to remove the suction device from the window assisting with the removal of the protective device from the vehicle. The suction devices are attached to the top section of the support belt.

The SUV Rear Bumper Protector Bonnet is a nominal 54 inches in the middle of Bumper protective Bonnet (94) that can be adjusted and made to fit the size of vehicles larger or smaller. FIG. 13: 95, are 1 inch seams with elastic sewn inside for stretching which gives the protective device the ability to fit snug.

FIG. 13: 96, illustrates the width of the Bumper Protective Bonnet which is a nominal 12 feet wide that can be adjusted and made to fit the size of vehicles larger or smaller. FIG. 13: 97, is an optional padding for added protection.

FIG. 13: 89 Grommet, 90: Suction Device, 91: Support Belt, 92: Top side of Bumper Guard, 93: Bottom side of Bumper Guard, 94: 54 inches in the middle of Bumper Guard, 95: 1 inch seams with elastic sewn inside, 96: Nominal 12 feet wide that adjusts with the size of the vehicle, 97: Optional thin padding, 98: Removal Devices, 99: 25 inch tapered ends of Bumper Protector Bonnet, 100: Water Resistant Material

FIG. 14: Front Bumper Protector Bonnet with Optional Soft Thin Padding

FIG. 14 illustrates an alternative embodiment to the current invention. This alternative option gives detail to the alternative optional soft padding (101) added to the lining of the Front Bumper Protector Bonnet. The padding adds an even higher degree of protection to the vehicle front bumper.

FIG. 15: Rear Bumper Protector Bonnet with Optional Soft Thin Padding

FIG. 15 illustrates an alternative embodiment to the current invention. This alternative option gives details to the alternative optional soft padding (107) added to the lining of the Rear Bumper Protector Bonnet. The padding adds an even higher degree of protection to the vehicle rear bumper.

FIG. 16: Front and Rear Bumper Protector Bonnet Conjoined to Side Padding with Soft Padding in the Front and Rear Bumper Protective Bonnet

FIG. 16: illustrates an alternative embodiment Bonnet covered with a water resistant material (125) with all of the features of the Front and Rear Bumper Protector Bonnet conjoined with the driver and passenger side 5 piece padding but specifically details the alternative optional soft padding (118) added to the lining of the Front and Rear Bumper Protector Bonnet. The padding adds an even higher degree of protection to the vehicle it protects. The padding is sewn in the inner lining of the water resistant material that is used in the making of the Front and Rear Bumper Protector Bonnet.

The protective device is a nominal five piece padded sheets conjoined with the Front and Rear Bumper Protector Bonnet. The padded sheets can be configured to fit larger or smaller vehicle by adding or removing one or more soft padded sheets. The door, dent, ding, and scratch protector and protective device protects the front and rear bumper with an added water resistant material with contoured ends that conjoins to the ends of both drivers and passengers side nominal 5 piece soft pad protective sheets.

The Front and Rear section of the protective device is made with elastic (119) sewn in the seams. The elastic permits the vehicle protective device to fit snug preventing the protective device from blowing off during a strong wind. Both driver and passenger side has two support belts (124) attached to the protective padding. Each belt has two grommets (123) with a design such as a circle with a hole in the center which allows a suction device to feed through it and attach to the support belt. At the end of each suction device is a removal device (122) such as a ring or another suitable type of removal device that is designed to remove the device from the vehicle. The suction devices are attached to the top and bottom section of the support belt. The Front and Rear Bumper Protector Bonnet conjoined with the side padding illustrating all pieces as one complete vehicle protective device.

FIG. 16, 113: Front Bumper Protector Bonnet, 114: 12 foot long Bumper Protector Bonnet that adjusted to the size of the vehicle, 115: Conjoined Section, 116: Rear Bumper Protector Bonnet, 117: Bottom of Bumper Protector Bonnet, 118: Optional Padding, 119: 1 inch seams with elastic sewn inside, 120: Bumper Protector Bonnet ends tapper to 25 inches, 121: Suction Devices, 122: Removal Devices, 123: Grommets, 124: Support Belt, 125: Water Resistant Material

### DETAILED DESCRIPTION OF THE INVENTION

Preferred embodiments of the present invention are illustrated in FIG. 1, FIG. 2, FIG. 3, FIG. 4, FIG. 5, and FIG. 6. Alterative embodiments and options of the preferred embodiment are listed in FIG. 7, FIG. 8, FIG. 9, FIG. 10, FIG. 11, FIG. 12, FIG. 13, FIG. 14, FIG. 15, and FIG. 16. These are alterative embodiment's and options of the preferred embodiment of this current present invention Vehicle Door Dent, Dings, and Scratch Protector and Protective Device and are listed in detail below.

The present invention Vehicle Door Dent, Ding and Scratch Protector and Protective Device is a nominal five piece soft light weight high density padding material covered in a soft water resistant material designed to prevent accidental dents, dings, and scratches caused mostly by the opening of other vehicles parked too close. The front and rear soft material sections illustrated as Front and Rear Bumper Protector Bonnet are designed to snug the front and rear areas of the vehicle.

The protective device fits around the vehicle and protects the front and rear driver side door, front and rear passenger side doors, front and rear bumpers, front and rear quarter panels, front hood and rear trunk from minor dents, dings, and scratches caused mostly by the opening of the doors of adjacent vehicles parked too close.

The present invention also protects against objects that may make contact with the vehicle while those object lay against an unstable area. As the vehicle is left unattended objects may make contact with the vehicle. The protective device in this patent protects against objects such as a shopping cart, bicycle, and garden tool, accidental scratch from children playing to close the vehicle, or a passing individual who may accidentally scratch or intentionally attempt to scratch the vehicle.

The protective device is held up by support belts with suction devices that attach to the window of the vehicle. As an alternative option support belts with adjustable connectors or locking and unlocking adjustable connectors are added that permit the support belt to lie over the roof of the vehicle. Both connectors allow the support belt to adjust smaller or larger to fit smaller of larger vehicles.

The present invention has an alternative embodiment designed to protect the rear bumper of SUV type vehicles and vehicles without an extended bumper. The SUV rear Bumper Protector has two support belts with one suction device and a removal device attached to each belt. The suction devices are attached to the top section of the belt which keeps the device form falling during and after installation. At the end of the suction device is a removal device which allows the device to be easily removed. The rear bumper protector section is conjoined to the five piece soft padding. This section of SUV bumper protector fits as of that of a bonnet thus given the name SUV Rear Bumper Protector Bonnet.

The Front and Rear Bumper Protector Bonnet are attached and or conjoined to the drivers and passengers side nominal five piece soft padding material extending the scratch protection to the complete perimeter of the vehicle. The Vehicle Door Dent, Ding, and Scratch Protector and protective device can be configured to protect larger or smaller vehicles by adding or removing sections of the soft padding sheets, or adding or removing sections in measurements from the front and or rear bumper protective bonnet section.

This Vehicle Protective Device protects the front and rear bumpers including the front hood and rear trunk areas with a higher degree of protection from the conjoined optional padded protective material described as the front and rear Bumper Protector Bonnet. Each soft, padded sheet provides dent, ding and scratch protection to the vehicle's front and rear doors, and front and rear quarter panels protecting the driver and passenger's side of the vehicle from minor scratches dents, and dings.

The Vehicle Door Dent, Ding and Scratch Protector and Protective Device also protect vehicles without a rear trunk such as SUV's. Support belts with suction devices are added as an alternative option to the rear bumper scratch protector. The SUV bumper protector is held up by support belts with suctions devices. The Front Bumper Protector and the SUV Rear Bumper Protector Bonnet are conjoined to the drivers and passengers side nominal five piece soft padding material.

The Front and Rear Bumper Protector Bonnet are conjoined to the drivers and passengers side nominal five piece soft padding material. The protection is extended and increases the scratch protection to the drivers and passengers front and rear quarter panels, and front and rear bumpers of the vehicle. The Vehicle Door Dent, Ding, and Scratch Protector and Protective Device can be configured to protect larger or smaller vehicles by adding or removing sections of the soft padding material sheets.

The protective device is also designed to protect the vehicle with alternative options including the top of the vehicle which is detailed as an alternative option of this patent. A top section of Water Resistant material is added to the top section of the Vehicle Door Dent, Ding and Scratch Protector and Protective Device. By adding this section to the protective device it becomes a full Vehicle Protective Device protecting the drivers and passengers sides from minor dents, dings and scratches, the front and rear bumper from scratches, and protecting the top from the elements and minor scratches.

### Installation

### Vehicle Door Dent, Ding and Scratch Protector and Protective Device

See FIG. 6:

The Protective Device is installed by starting at the front or back of the vehicle then securing the Bumper Protector Bonnet around bumper. Next is to affix the suctions devices to either the drivers or passenger's side window depending on which side the user starts on. Next is to pull the remaining protective device over the vehicle pulling it until it reaches the opposite bumper. Next is to pull the remaining Bumper Protector Bonnet over the bumper and secure the remaining end of the Bumper Protector Bonnet over the bumper so that it fits snug. Next is to open the doors and insert the belts in the door jams between the section of the driver's window and metal frame of the passenger's door, affix the suctions devices to the inner side window, and close the door.

### Vehicle Door Dent, Ding and Scratch Protector and Protective Device Driver and Passenger Side Protection Only

### See FIG. 7:

The side protection only option is installed by throwing the protective device over the top of the vehicle and affixing the suction devices to the outer side of the window. It is then secured by opening the doors and inserting the support belts in the door jams between the section of the driver's window and metal frame of the passenger side door, affix the suctions devices to the inner side window, and close the door. The option also illustrates the installation of the padded mirror covers that fits over the mirrors after the side protection only has been installed.

Vehicle Door Dent, Ding and Scratch Protector and Protective Device with Top Protector

See FIG. 8:

The Protective Device is installed by starting at the front or back of the vehicle then securing the Bumper Protector Bonnet around bumper. Next is to pull the remaining protective device over the vehicle pulling it until it reaches the opposite bumper. Next is to pull the remaining Bumper Protector Bonnet over the bumper and secure the remaining end of the Bumper Protector Bonnet over the bumper so that it fits snug.

Vehicle Door Dent, Ding and Scratch Protector and Protective Device with Driver to Passenger Connecting Support Belts and Locking and Unlocking Connectors

See FIG. 9:

Protective Device is installed by starting at the top of the vehicle. Let the two sides of the protective device drop on both sides until the support belts support the device from falling. Unlock one belt at a time leaving the remaining belt to support the protective device. Adjust the belt and secure the lock. Repeat for the second belt. Secure the Bumper Protector Bonnet around the front or back bumper. Next is to pull the remaining protective device over the vehicle pulling it until it reaches the opposite bumper. Next is to pull the remaining Bumper Protector Bonnet over the bumper and secure the remaining end of the Bumper Protector Bonnet over the bumper allowing it to fit snug. Next is to adjust the connectors so that the protective padding fits to the optimal setting allowing for the best possible fit and protection. Next is to open the doors and insert the belts in the door jams between the section of the driver's window and metal frame of the passenger's door, affix the suctions devices to the inner side of the driver and passenger side window, and close the door.

### FIG. 10 SUV Rear Bumper Protector Bonnet

See FIG. 10:

The Protective Device SUV is installed by starting at the front or back of the vehicle then securing the Bumper Protector Bonnet around the bumper. Next is to pull the remaining protective device over the vehicle pulling it until it reaches the opposite bumper. Next is to pull the remaining Bumper Protector Bonnet over the bumper and securing the remaining end of the Bumper Protector Bonnet over the bumper so that it fits snug. Next is to open the doors and insert the belts in the door jams between the sections of the driver's window and metal frame of the passenger's door, affix the suctions devices to the inner of the side and rear windows, and close the door.

The Protective Device Separation Option with Connectors

See FIG. 11:

The separation with connectors illustrates an installation option. The protective device can either be installed by starting at one end of the vehicle or the other securing the suction devices to the window, and wrapping the protective device around the vehicle until both ends meet, then locking the connectors together securing the protective device enabling it from loosening or falling down.

The SUV type protective device alternative option with locking connector, can either be installed by starting at the front of the vehicle or the back end securing the suction devices to the window, and wrapping the protective device around the vehicle until both ends meet, then locking the connectors together securing the protective device enabling it from loosening or falling down. Insert the ends of the support belts into door jams between the section of the driver's window and frame of the driver and passenger's door, affix the suctions devices to the inner side of the and window, and close the door.

FIG. 12: Detailed Alternative Option of Protective Device with Adjustable Connectors

See FIG. 12:

The Door Dent, Ding and Scratch Protector and Protective Device without connectors or suction devices assembled to the driver to passenger support belts.

The Protective Device is installed by starting at the top of the vehicle. Let the two sides of the protective device drop on both sides until the support belts support the device from falling. Secure the Bumper Protector Bonnet around the front or back bumper. Next is to pull the remaining protective device over the vehicle pulling it until it reaches the opposite bumper. Next is to pull the remaining Bumper Protector Bonnet over the bumper and secure the remaining end of the Bumper Protector Bonnet over the bumper allowing it to fit snug. Next is to adjust the connectors so that the protective padding fits to the optimal setting allowing for the best possible fit and protection. Next is to open the doors and insert the belts in the door jams between the section of the driver's window and metal frame of the passenger's door, affix the suctions devices to the inner side of the driver and passenger side window, and close the door.

### CONCLUSION

From nearly the beginning of the invention of the automobile inventors have tried to design a protective device that would protect the vehicle/car finish from unsightly dents, dings, and scratches that reduces the value the vehicle. Many inventions exist however one or two elements would keep other protective devices from unlocking the code that would satisfy the public's need and give automobile owners the ease and comfort of using such products specifically designed to fill that need.

With the introduction of the parking lot insisting that vehicles would have to park next to each other in order to bring in mass number of people in one area, inventers have tried to design an effective protective device. One that would protect the perimeter of the vehicle that is lightweight, and fairly easy to install.

The present invention and the options that it offers are clearly designed to meet those specifications and address the limitations with intent of eliminating dents, dings, and scratches.

This invention clearly offers relief from the costly unsightly scratches, the elimination of the abundance and unlimited minor door dents, and dings that are so generously offered in the parking lot from grocery store shoppers, or abundantly non-deliberately given by the hurried employee who is running late in the work parking lot after the vehicle has been parked.

The Vehicle Door Dent, Ding and Scratch Protector and Protective Device is versatile and unique, and gives the end user installation and protection options. The protective device in this present invention not only protects the vehicle from the unseen giving of unsightly minor dents, dings, and scratches, but has also been designed to add beauty and elegance to the vehicle it protects.

The importance and urgency of this present invention is to add to the effort of limiting minor dents, dings and scratches to what many are calling a major investment. This patent is the beginning of a combination of preventative measures in hopes to defeat these types of vehicle finish damaging issues. What the intent for this present invention is for inventors to expand on these ideas and what these ideas offer to vehicle industry to spark up the imagination of inventors to improve and advance on what is now a hopeful solution to a broader vision of vehicle body and finish protection.

The extreme importance to the value of what this present invention brings cannot be selfishly kept to one person as it is with great hope that science minded inventors add to the advancement of what is hopefully to become the beginning of the end of door dents, dings, and scratches to the body and finish of vehicle/car.

First, what I claimed is:

1. The Vehicle Door Dent, Ding, and Scratch Protector and Protective Device is made of a nominal five piece conjoined foldout soft padding material that is applied to both the driver and passenger side. Each piece is attached and conjoined to each other by one or more flexible stabilizer belts for added hinging stability as seen in FIG. 1: 4, and FIG. 2: 2. The belts are located between each connecting fold also known as joint. The flexible stabilizer belts allows for strength and stability and also allows each section to fold inward and outward while allowing the device to fold and collapse in an accordion type of fold for ease of storage. The belts also protect each section from separating during installation and storage return. Each support belt is positioned on the opposite side of each fold allowing each section to fold in and out separately. To fit larger or much smaller vehicles one or more panels sections of the soft padding conjoined foldout protective device can be added or removed from both the driver's side and passenger's side of the protective device.
Second, what I claim is:
A soft fabric water resistant material that covers and protects the front and rear bumper defined as Front and Rear Bumper Protector Bonnet Each Bumper Protector Bonnet is a vehicle standard size of 12 feet in length and will vary larger or smaller in size depending on the size of the vehicle.
The variation in size of each Front and Rear Bumper Protector Bonnet is from 8 feet or smaller in length for smaller vehicles, and 16 feet or larger in length for larger vehicles depending on the length and size of the vehicle. The width of each Bumper Protector Bonnet is 54 inches and will vary larger or smaller in size depending on the size of the vehicle. Both ends of the Bumper Protector Bonnet tapers down from a width of 54 inches at the center of the Bumper Protector Bonnet to a width of 25 inches at each end, and are attached, and conjoined together with the drivers and passengers side vehicle door dent, dings, and scratch protector soft padding.
An elastic band is sewn inside the top and bottom seams of the front and rear Bumper Protector Bonnet soft fabric water resistant material.
The elastic that is sewn in the seam of the top and bottom of the Bumper Protector Bonnet is designed and used to hold the vehicle door dent, ding and scratch protector in place with a snug fit preventing it from moving, falling, or being blown off during strong winds. The Bumper Protector Bonnet together with the drivers and passengers side soft padding protector and protective device wraps around the complete vehicle. The soft fabrics water resistant material adds additional scratch protection to the front and rear bumper of the vehicle.
Third, what I claim is:
A second optional Rear Bumper Protector Bonnet for SUVs and vehicles without an extended rear trunk or extended bumper. This Bumper Protector Bonnet is designed with two support belts, removal devices and suction devices attached to the Rear Bumper Protector Bonnet. The SUV Rear Bumper Protector Bonnet is conjoined to the soft padding and Water Resistant material.
It is designed to fit vehicles without extended rear bumpers such as a Sport Utility Vehicle \ SUV's, and smaller vehicles with a hatch back. The support belts are attached to the top section of the rear Bumper Protector Bonnet. The support belts and suction device and removal devices assembly that are attached to the Bumper Protector Bonnet are designed to attach to the rear window of the vehicle. This attachment provides stability and support and adds ease of installation and removal, and prevent the rear Bumper Protector Bonnet from falling down during and after installation while the protective device is on and protecting the vehicle.
Fourth, what I claim is:
The support belts are nylon or a material such as with 2 suction devices and removal devices attached to each belt and 12 at which are attached to the top section of driver and passenger side Vehicle Door Dent, Ding and Scratch Protector soft padding, The suction devices are attached to the belts, and used to hold the protective device up during and after installation. The first suction device attached to the lower section of the support belt closest to the soft padding will attach to the outer side of the window during installation. This belt assembly will allow the Vehicle Protector to stay up and in place during and after installation. The second suction device attached to the upper area of the support belt attaches to the internal side of the driver and passenger side window. The second suction device allows for a non slip secure hold that is then closed between the window and the door frame. This adds additional reinforcement to the protective device further preventing it from falling. The removal devices are to pull and remove the suction devices from the window. The support belt and suction devices also add security to the vehicle protector adding a degree of difficulty from unwanted removal.
What I claim are, options of the present invention are as follows
The following are options of the vehicle door dent, dings, and scratch protector and protective device: The soft padding protective device is configured with different options to meet the end users needs.
Fifth, what I claim is as an alternative Option 1:
Made to Fit Adding or Reducing the Number of Padded Sheets
The Vehicle Door Dent, Dings, Scratch Protector and Protective Device can be made to fit larger and smaller vehicles. To fit larger or smaller vehicles one or more panels sections of the conjoined soft padding foldout protective device sheets can be added or removed from both the driver's side and passenger's side, and the sizes of the length and or the width of the Front and Rear Bumper Protector Bonnet can be increased or decreased to fit larger or smaller vehicles.
Sixth, what I claim is as an alternative Option 2:
FIG. 3: Padded Front and Rear Bumper Protector Bonnet
The Front and Rear Bumper Protector Bonnet is designed with an option to add and sew in a soft pad to the inner padded lining of the Bumper Protector Bonnet. The padding and soft fabric adds a higher degree of protection from scratches while parked and unattended. This option protects the vehicle from scratches due to high traffic volume when the vehicle is parked in parking lots, garages or tight areas where constant walking and traffic of the sort that might pass by and accidently scratch the front or rear of the vehicle bumper, or in many cases children riding their bicycles and leaning it against the front or rear of the vehicle. This option will protect the vehicle against such unintentional minor damages and maintain the beautiful shine of the vehicles finish.
Seventh, what I claim as an alternative Option 3:
FIG. 7: Door Dent, Ding and Scratch Protector and Protective Device Driver and Passenger side protection only with padded mirror covers
The vehicle protective device as seen in FIG. 8 can be configured without the Bumper Protector Bonnets for individuals who are on the go and need fast protection in a pinch. This application provides protection specifically to the sides of the vehicle including the side mirrors allowing for fast and easy installation and removal of the protective device.
This application connects the driver's side and passenger side protective padding together with adjustable support belts. Each support belt is attached together as one using one connector per belt. The connectors allow the device to lie over the roof of the vehicle and the support belt assembly to be adjusted to fit different vehicle sizes allowing the user to adjust the belts to fit the width and size of their vehicle specification.
Eight, what I claim is as an alternative Option 4:
FIG. 7: Optional Support belts
This option replaces the original four separate support belts with two support belts. The two belts are a nominal 26 inches long with suction devices, removal devices, and connectors that lock and unlock. The belts are made longer for an option in application that removes the separation between the four support belts and converts them to two support belts. The belts will lie across the top of the vehicle. This option allows the user to adjust the belts to a length of 90 inches or longer or shorter depending on the size of the vehicle. The extra belt length allows for alternative options when installing and to hold the Protective Device up during and after installation. The remaining ends of the support belts can be inserted between the door Jam and window of the vehicle to prevent unwanted protective device removal. The Support Belt option can also be configured with or without the suction devices assembly.
Ninth, what I claim is as an alternative Option 5:
FIGS. 8: 2 and 3,
Optional Protective Device without Front or Rear Bumper Protector Bonnet
FIG. 8 illustrates an alternative embodiment option that removes the front and rear Bumper Protector Bonnet from the Vehicle Door Dent, Ding, and Scratch Protector and Protective Device five piece padding. The driver's side and passenger side are connected together with support belts with adjustable connectors. On both the drivers and passenger side are Slider Belts and padded mirror covers attached to the five piece conjoined padding that protects the mirror from being scratched by individuals passing by. The slider belts allow the padded mirror cover to slide forward and reverse giving it adjustability for vehicles with mirrors in different positions allowing the Padded Mirror Cover to fit any vehicle.
Tenth, what I claim is, as an alternative Option 6:
FIG. 8: Added Top Protection Five Piece Protective Device
The protective device is designed with an optional top protective add on conjoining the top section of Water Resistant material fabric to the upper padding and front and rear bonnet section of the Vehicle Door Dent, Ding and Scratch Protector and Protective Device. This addition to the already protective lower section becomes a full vehicle protective device protecting the drivers and passengers sides, the front and rear bumper from minor dents, dings and scratches, also protecting the vehicle from direct sunlight, bird droppings, and unforeseeable dust issues that could scratch the beautiful finish while parked in or out of the garage. The top section has an option to add a soft thin padding sewn in the lining of the Water Resistant material giving the top section a higher degree of scratch protection making the present embodiment a full and complete vehicle protective device.
Eleventh, what I claim is as an alternative option 7,
FIG. 9: Side Mirror Protectors, Adjustable Padded Cover for Side Mirrors
The Padded Cover for Side Mirrors option allows for scratch and ding protection for the driver and passenger side mirrors. The side mirror protectors are padded mirror covers attached to the five piece conjoined vehicle protective device. The Padded Mirror Cover which protects the mirror and is attached to the vehicle five peace protective devices with a bidirectional slider belt. The Padded Mirror Cover is conjoined to the soft padding foldout protective device. The assembly allows the padded mirror cover to slide forward or backward enabling it to adjust and fit different mirror positions of various vehicles. The Adjustable Side Padded Mirror Protector is an option that can be added to any part of this invention.
Twelfth, what I claim is as an alternative Option 8,
FIG. 9: Exploded View of Support Belt without Connectors or Suction Devices
FIG. 9: See exploded view of support belt without connectors or suction devices. The connecting support belts are attached to the drivers and passengers side protective padding and do not adjust for different vehicle sizes, but rather are pre cut to a specific length depending on the request of the user per the vehicle size. The length of the support belt will depend on the size, make and model of the vehicle. The support is used to support the protective device and prevent from falling down during and after installation.
Thirteenth, what I claim is as an alternative option 9,
FIG. 10: SUV Bumper Protector Bonnet
The SUV Rear Bumper Protector Bonnet designed for SUVs and vehicles without an extended rear trunk compartment and or extended bumper as seen in FIG. 5: This SUV Bumper Protector Bonnet adds two support and suction devices to the Bumper Protector. This option is designed to fit vehicles without extended rear bumpers such as a Sport Utility Vehicle \ SUV's, and smaller vehicles with hatch backs. The support belts are attached to the top section of the rear Bumper Protector Bonnet. The support belts and suction device assemblies that are attached to the Bumper Protector Bonnet are designed to be affixed to the rear window of the vehicle. This attachment provides stability and support to the protection device and adds ease of installation, and prevents the rear Bumper Protector Bonnet from falling down during and after installation.
Fourteenth, what I claim is as an alternative Option 10:
FIG. 11: Bumper Proctor Bonnet Connector at Separation
The Vehicle Door Dent, Dings, and Scratch Protector and Protective Device is designed with an optional separation between the Bumper Protector Bonnet and soft padding side protective section of the protective device. A minimum of three connectors are added to the separation which will allow the protective device to separate during the installation. The option assists with the complication of installation on much larger vehicles and individuals who are shorter in physical stature. This option is for the locking and unlocking of the connectors to allow the protective device to be installed by starting at one end of the vehicle and wrapping the protective device around the vehicle until both ends meet, then locking the connectors securing the protective device enabling it from loosening and falling down. The connector allows for ease of quick connect and disconnect between the two separated pieces during installation and un-installation.
Fifteenth, what I claim is as an alternative Option 11,
FIG. 12: Vehicle Door Dent, Dings, and Scratch Protective Device with Adjustable Connectors
This option replaces the original four separate support belts with two support belts. The two belts are a nominal 26 inches long with connectors that allow the belts to adjust. The belts are made longer for an option in application that removes the separation between the four support belts and converts them to two support belts. The support belts will lie across the top of the vehicle. This option allows the user to adjust the belts to a length of 90 inches or longer or shorter depending on the size of the vehicle. The extra belt length allows for alternative options when installing and to hold the Protective Device up during and after installation. The remaining ends of the support belts can be inserted between the door Jam and window of the vehicle to prevent unwanted protective device removal. The Support Belt option can also be configured with or without the suction devices assembly.
